(19) United States
(12) Patent Application Publication
(10) Pub. No.: US 2017/0206253 A1
(43) Pub. Date: Jul. 20, 2017

(54) COMMUNICATION OF EVENT-BASED CONTENT

(71) Applicants: Chun-Yang WANG, Shanghai (CN); Qing-Yi WANG, Shanghai (CN); Ye LIU, Shanghai (CN); HEWLETT PACKARD ENTERPRISE DEVELOPMENT L.P., Houston, TX (US)

(72) Inventors: Chun-Yang WANG, Shanghai (CN); Qing-Yi WANG, Shanghai (CN); Ye LIU, Shanghai (CN)

(73) Assignee: HEWLETT PACKARD ENTERPRISE DEVELOPMENT L.P., Houston, TX (US)

(21) Appl. No.: 15/306,722

(22) PCT Filed: Sep. 30, 2014
(86) PCT No.: PCT/CN2014/087870

§ 371 Date: Oct. 25, 2016

(51) Int. Cl. G06F 17/30

(52) U.S. Cl. CPC G06F 17/30554; G06F 17/30528; G06F 17/30165; G06F 17/30598

(57) ABSTRACT

Examples relate to communication of event-based content. The examples disclosed herein enable obtaining, by a first server computing device, a first event that is generated by a second server computing device based on a first request from a first user. The first event may comprise a first set of contextual attributes that describe the first event. The examples disclosed herein further enable identifying, by the first server computing device, a first set of content categories that are related to the first event and obtaining, by the first server computing device, first content for at least one of the first set of content categories. The first content may be determined based on at least one of the first set of contextual attributes. The examples disclosed herein further enable providing, by the first server computing device, the first content to a client computing device of the first user.

### BACKGROUND

The amount of information available from the Internet and in an enterprise environment (e.g., within a business) is continually on the rise, making it challenging to find desired content that may be buried in this sea of information. In order to obtain the desired content, the user may use a search engine to search for the content. This may require the user to take multiple steps, including finding a set of search keywords, accessing multiple databases, reviewing a list of search results, and selecting desired content from the results. Some databases may not be easily accessible and may require the user to login, or authenticate, prior to accessing the databases, adding extra steps to the search process. Moreover, the user may need to store the selected content in such a manner that the content can be easily accessible by the user.

### BRIEF DESCRIPTION OF THE DRAWINGS

The following detailed description references the drawings, wherein:

FIG. 1 is a block diagram depicting an example environment in which various examples may be implemented as an event-based content system.

FIG. 2 is a block diagram depicting an example event-based content system.

FIG. 3 is a block diagram depicting an example machine-readable storage medium comprising instructions executable by a processor for communicating event-based content.

FIG. 4 is a block diagram depicting an example machine-readable storage medium comprising instructions executable by a processor for communicating event-based content.

FIG. 5 is a flow diagram depicting an example method for obtaining content determined based on an event that is generated by an external transactional system.

FIG. 6 is a flow diagram depicting an example method for sharing an event with another user.

FIG. 7 is a flow diagram depicting an example method for providing an event summary.

FIG. 8 is a diagram depicting an example user interface for displaying an event stream and managing events in the event stream.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The amount of information available from the Internet and in an enterprise environment (e.g., within a business) is continually on the rise, making it challenging to find desired content buried in this sea of information. In order to obtain the desired content, the user may use a computing device such as a laptop to search for the content. This may require the user to take multiple steps, including finding a set of search keywords, accessing multiple databases, reviewing a list of search results, and selecting desired content from the results. Some databases may not be easily accessible and may require the user to login, or authenticate, prior to accessing the databases, adding an extra step to the search process. Moreover, the user may need to store the selected content in such a manner that the content can be easily accessible by the user. For example, the user may print the content using a printer.

Examples disclosed herein address these issues by providing an event-based content system that may enhance communication and delivery of content relevant to the user's current needs. The event-based content system may be integrated with external transactional systems that may generate an event and publish it along with contextual attributes associated with the event to the event-based content system. The contextual attributes of the event may be used to obtain content items to be recommended for a set of content categories associated with the particular event. Further, the event-based content system may have knowledge about the relationships among users in an enterprise environment where interactions of a particular user with a first content item recommended to the user may be used to generate a second content item for another “related” user in the enterprise environment.

An “event,” as used herein, may comprise any event that comprises a set of contextual attributes that describe the event. “Contextual attributes” may refer to a set of properties and/or characteristics of the event. The contextual attributes may comprise at least one of temporal context (e.g., a departure time), locational context (e.g., a departure city), user context (e.g., user information such as name, age, gender, home address, phone number, social media account, etc.), and/or other contexts.

For example, the event may be a “business travel” event where the contextual attributes related to the “business travel” event may include a departure time, an arrival time, a departure city, an arrival city, and/or other information known about this business trip. In another example, the event may be a “customer interview” event whose contextual attributes may include any information known about the upcoming customer interview. In this example, the contextual attributes may include the name of the customer's company, the company address, the meeting time, the name of a contact person, and a phone number for the contact person.

A “content category,” as used herein, may refer to a particular topic, subject, and/or class of information. Content items that belong to a particular content category may share the common topic, subject, and/or class of information. An event may be associated with a predefined set of content categories. For example, the “business travel” event may be associated with various content categories including flight, weather, map, hotel, currency, car rental, etc.

A “content item,” as used herein, may comprise text, image, video, audio, or any combination thereof.

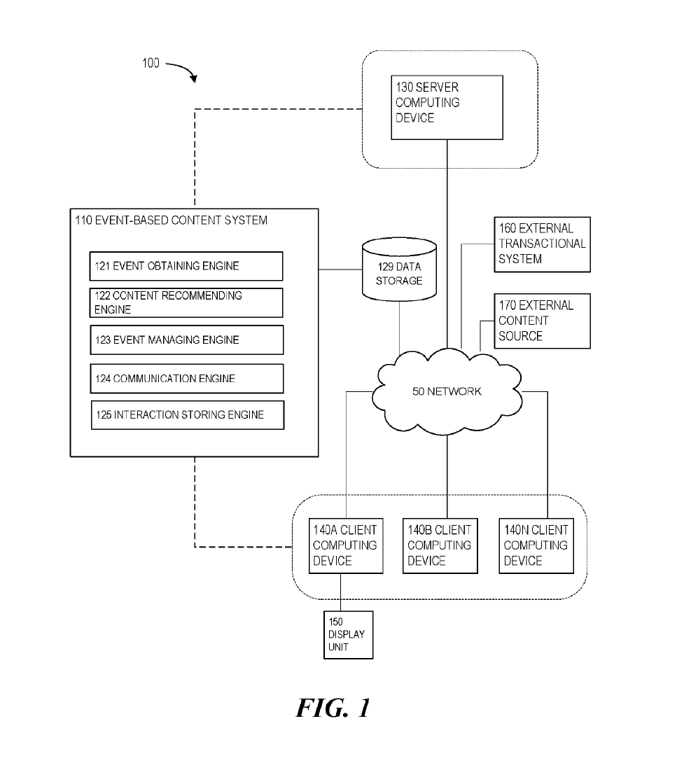

FIG. 1 is an example environment 100 in which various examples may be implemented as an event-based content system 110. Environment 100 may include various components including server computing device 130 and client computing devices 140 (illustrated as 140A, 140B, . . . , 140N). Each client computing device 140A, 140B, . . . , 140N may communicate requests to and/or receive responses from server computing device 130. Server computing device 130 may receive and/or respond to requests from client computing devices 140. Client computing devices 140 may be any type of computing device providing a user interface through which a user can interact with a software application. For example, client computing devices 140 may include a laptop computing device, a desktop computing device, an all-in-one computing device, a tablet computing device, a mobile phone, an electronic book reader, a network-enabled appliance such as a “Smart” television, and/or other electronic device suitable for displaying a user interface and processing user interactions with the displayed interface. While server computing device 130 is depicted as a single computing device, server computing device 130 may include any number of integrated or distributed computing devices serving at least one software application for consumption by client computing devices 140. A display unit 150 may be coupled to a client computing device (e.g., client computing device 140A) to display and/or render a display of information communicated to the client computing device. Display unit 150 may comprise a touch-screen display via which a user can interact with the client computing device and/or a software application.

External transactional system 160 may comprise at least one external transactional system that may be integrated with event-based content system to generate an event and publish or otherwise provide the event along with associated contextual attributes to event-based content system 110.

External content source 170 may comprise at least one external content source that may provide a content item to event-based content system 110. Examples of external content source 170 may include a content source providing content related to weather, traffic, hotel booking, social media, news, etc.

The various components (e.g., components 129, 130, 140, 150, 160, and/or 170) depicted in FIG. 1 may be coupled to at least one other component via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, event-based content system 110 and the various components described herein may be implemented in hardware and/or a combination of hardware and programming that configures hardware. Furthermore, in FIG. 1 and other Figures described herein, different numbers of components or entities than depicted may be used.

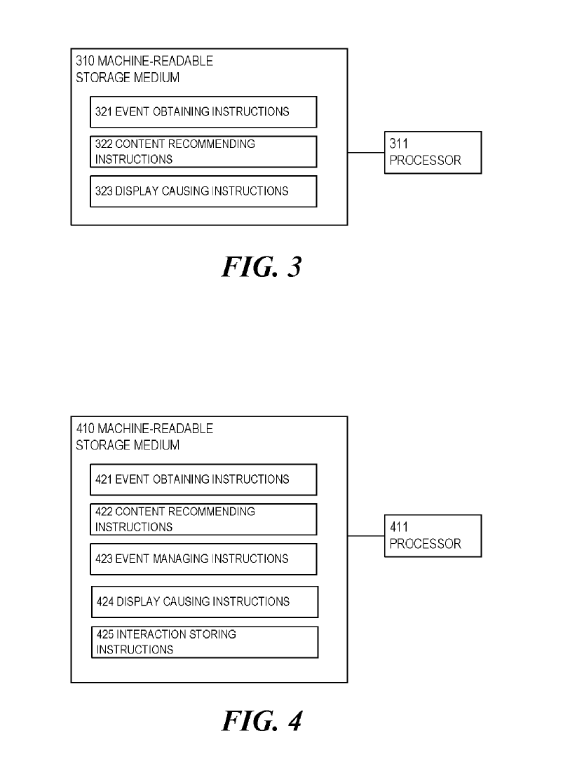

Event-based content system 110 may comprise an event obtaining engine 121, a content recommending engine 122, an event managing engine 123, a communication engine 124, an interaction storing engine 124, and/or other engines. The term “engine”, as used herein, refers to a combination of hardware and programming that performs a designated function. As is illustrated respect to FIGS. 3-4, the hardware of each engine, for example, may include one or both of a processor and a machine-readable storage medium, while the programming is instructions or code stored on the machine-readable storage medium and executable by the processor to perform the designated function.

Event obtaining engine 121 may obtain an event comprising a set of contextual attributes that describe the event. The event being obtained may be generated in various ways. In some implementations, the event may be generated by an external transactional system 160 (e.g., a second server computing device) that is integrated with event-based content system 110 (e.g., a first server computing device). External transactional system 160 may publish or otherwise provide the generated event to event-based content system 110.

For example, a user may submit a helpdesk ticket through a first external transactional system, which may include at least one contextual attribute such as the user's identification, the user's contact information, the issue that needs to be resolved, an importance level, a ticket creation time, etc. The first external transactional system may publish or otherwise provide the helpdesk ticket along with the contextual attributes associated with the ticket to event-based content system 110. In another example, a user may purchase an airplane ticket through a corporate travel agency. A second external transactional system that facilitates the airplane ticket purchase may generate an event that comprises contextual attributes that may be extracted from the airplane ticket purchase information, which may include a departure time, an arrival time, a departure city, an arrival city etc. In another example, a third external transactional system that manages calendars, meetings, appointments, etc. may communicate with event-based content system 110 such that a meeting created in the third external transactional system and the information (e.g., a meeting time, the meeting location, the name of a contact person, etc.) about the meeting may be provided to event-based content system 110.

In some implementations, the event may be generated by event-based content system 110. For instance, a user through a client computing device (e.g., client computing device 140A) that is in communication with server computing device 130 may create an event by specifying contextual attributes of the event such as by filling out a form.

As discussed above, the event and/or accompanying contextual attributes may be generated manually by user input (e.g., filling out a form) and/or automatically by various external transactional systems and/or event-based content system 110 (e.g., the contextual attributes extracted from the airplane ticket purchase information).

An event may be associated with a predefined set of content categories. For example, the “business travel” event may be associated with various content categories including flight, weather, map, hotel, currency, car rental, etc. The predefined associations between a particular event and a corresponding set of content categories may be stored in a data storage coupled to contextual-drive information system 110 (e.g., a data storage 129). Once event obtaining engine 121 obtains the event, content recommending engine 122 may identify a set of content categories associated with that event.

Content recommending engine 122 may obtain a content item to be recommended for each of the content categories in the identified set. The content item may be generated based on at least one of the set of contextual attributes of the event. In other words, the set of contextual attributes of the event may be used to generate content items for the content categories associated with the event. Returning to the above example, for the “weather” category associated with the “business travel” event, content recommending engine 122 may send the information about the arrival city to an external content source 170 such as a weather forecast service provider to retrieve and/or obtain the weather information related to the arrival city. The weather information related to the arrival city may be recommended to the user. For the “hotel” category, content recommending engine 122 may send the information about the arrival city to another external content source 170 such as a hotel booking service provider to retrieve and/or obtain the hotel or lodging information in the arrival city. The hotel information in the arrival city may be recommended to the user. Note that a content category may include more than one content items to be recommended to the user. For instance, the “weather” category may include the weather information of the arrival city as well as the weather information of the departure city.

Event managing engine 123 may generate an event summary that may comprise at least a portion of individual content items associated with the event. In some implementations, the event summary may include a snippet portion of individual content items associated with the event such that the user can receive a high-level overview of the entire event. The event summary of the “business travel” event, for example, may include a portion of weather content, a portion of hotel content, a portion of flight information content, etc.

Event managing engine 123 may enable sharing of the event with another user or a group of users. Event managing engine 123 may obtain, from a first user, a request to share the event with a second user. In response to the request to share, the event and associated content items may be communicated or otherwise provided to the second user.

Communication engine 124 may communicate, via a display, the event comprising at least a portion of the content item (obtained by content recommending engine 122 as discussed herein) to the user. For example, the user via display unit 150 coupled to the user's client computing device 140A may receive and view the weather information related to the city that he or she is visiting for his or her upcoming business trip. The event summary (generated by event managing engine 123) may be displayed via display unit 150. Any events shared by other users (via event managing engine 123) may be provided to the user via the display.

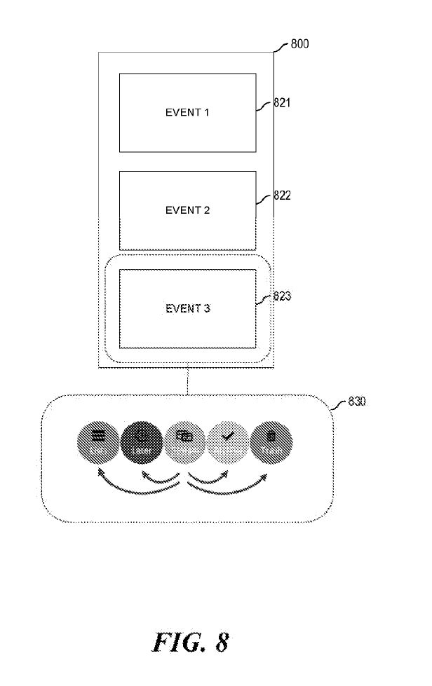

In some implementation, any new events communicated to the user may appear in the same display view (e.g., an “event stream”). This display view may function as an inbox for the new events. In one example, the events in the event stream may be arranged in a chronological order (based on the creation time of each event, the creation time of a content item in the event, a due date/time or an expiration date/time associated with the event or a content item in the event, the time of communication or delivery of the event or a content item in the event, etc.). In another example, the events in the event stream may be arranged based on an importance level, a priority level, a level of urgency, etc. In some implementations, the user may communicate which action the user wants to perform on a particular event appearing in the event stream using a swipe gesture on a touch-screen display. A “swipe” is a touch comprising an initial contact with the touch-screen display and a subsequent motion across the screen. For example, based on an indication of a swipe gesture with respect to a particular event, the user may easily snooze, archive, or delete the particular event. An example user interface for displaying the event stream is illustrated in FIG. 8.

In some implementations, communication engine 124 may stop communicating content items of the event to the user when the event is no longer active. The event may be associated with an event status comprising an active status and an inactive status. The active status may comprise information about the event being in progress and the inactive status comprises information about the event being closed, being complete, being expired, or not yet being started. When it is determined that the event is active based on the status associated with the event, communication engine 124 may cause a display of content items associated with the event. For example, for a “helpdesk ticket” event, the event may have an inactive status if the ticket has been resolved or otherwise closed. In this case, communication engine 124 may stop communicating any additional content items generated for the “helpdesk ticket” event to the user.

Interaction storing engine 125 may store interactions of a first user with at least one content item generated for the event. The information collected on the interactions may be used to influence a selection of a content item to be recommended for a second user who may have a pre-existing relationship with the first user. In an enterprise context, the first user and the second user may be related based on a practice, team, department, office, title, role, etc. For example, the first user and the second user may belong to the same team. When the first user creates a “business travel” event, a number of hotel selections may be recommended to the first user for the “hotel” category associated with the event. The first user may select one of the hotel selections that have been recommended and book a hotel reservation. The particular interaction (e.g., booking the hotel reservation) of the first user with the content item may be stored in a data storage (e.g., data storage 129). When the first user's team member (e.g., the second user) plans to make a business trip to the same city where the first user went to and creates a “business travel” event, the hotel where the first user stayed may be recommended to the second user. In some implementations, the content item that has been generated in part based on the interactions data stored in data storage 129 may be presented in a way that is noticeable to the second user. For example, the content item may be displayed with an icon that indicates that the interactions data has been used and/or may be displayed in a particular portion of the display (e.g., on the top of the display) that may be more noticeable to the user.

In performing their respective functions, engines 121-125 may access data storage 129 and/or other suitable database(s). Data storage 129 may represent any memory accessible to event-based content system 110 that can be used to store and retrieve data. Data storage 129 and/or other database may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. Event-based content system 110 may access data storage 129 locally or remotely via network 50 or other networks.

Data storage 129 may include a database to organize and store data. Database 129 may be, include, or interface to, for example, an Oracle™ relational database sold commercially by Oracle Corporation. Other databases, such as Informix™, DB2 (Database 2) or other data storage, including file-based (e.g., comma or tab separated files), or query formats, platforms, or resources such as OLAP (On Line Analytical Processing), SQL (Structured Query Language), a SAN (storage area network), Microsoft Access™, MySQL, PostgreSQL, HSpace, Apache Cassandra, MongoDB, Apache CouchDB™, or others may also be used, incorporated, or accessed. The database may reside in a single or multiple physical device(s) and in a single or multiple physical location(s). The database may store a plurality of types of data and/or files and associated data or file description, administrative information, or any other data.

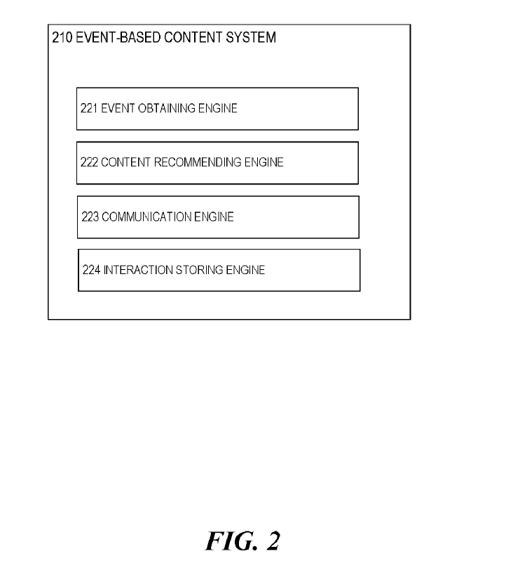

FIG. 2 is a block diagram depicting an example event-based content system 210. Event-based content system 210 may comprise an event obtaining engine 221, a content recommending engine 222, a communication engine 223, an interaction storing engine 224, and/or other engines. Engines 221-224 represent engines 121, 122, 124, and 125, respectively.

FIG. 3 is a block diagram depicting an example machine-readable storage medium 310 comprising instructions executable by a processor for communicating event-based content.

In the foregoing discussion, engines 121-125 were described as combinations of hardware and programming. Engines 121-125 may be implemented in a number of fashions. Referring to FIG. 3, the programming may be processor executable instructions 321-323 stored on a machine-readable storage medium 310 and the hardware may include a processor 311 for executing those instructions. Thus, machine-readable storage medium 310 can be said to store program instructions or code that when executed by processor 311 implements event-based content system 110 of FIG. 1.

In FIG. 3, the executable program instructions in machine-readable storage medium 310 are depicted as event obtaining instructions 321, content recommending instructions 322, and display causing instructions 323. Instructions 321-323 represent program instructions that, when executed, cause processor 311 to implement engines 121, 122, and 124, respectively.

FIG. 4 is a block diagram depicting an example machine-readable storage medium 410 comprising instructions executable by a processor for communicating event-based content.

In the foregoing discussion, engines 121-125 were described as combinations of hardware and programming. Engines 121-125 may be implemented in a number of fashions. Referring to FIG. 4, the programming may be processor executable instructions 421-425 stored on a machine-readable storage medium 410 and the hardware may include a processor 411 for executing those instructions. Thus, machine-readable storage medium 410 can be said to store program instructions or code that when executed by processor 411 implements event-based content system 110 of FIG. 1.

In FIG. 4, the executable program instructions in machine-readable storage medium 410 are depicted as event obtaining instructions 421, content recommending instructions 422, event managing instructions 423, display causing instructions 424, and interaction storing instructions 425. Instructions 421-425 represent program instructions that, when executed, cause processor 411 to implement engines 121-125, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411) may be integrated in a single device or distributed across devices. Further, machine-readable storage medium 310 (or machine-readable storage medium 410) may be fully or partially integrated in the same device as processor 311 (or processor 411), or it may be separate but accessible to that device and processor 311 (or processor 411).

In one example, the program instructions may be part of an installation package that when installed can be executed by processor 311 (or processor 411) to implement event-based content system 110. In this case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321-323, and/or other instructions. As an alternative or in addition to retrieving and executing instructions, processor 311 may include at least one electronic circuit comprising a number of electronic components for performing the functionality of at least one of instructions 321-323, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421-425, and/or other instructions. As an alternative or in addition to retrieving and executing instructions, processor 411 may include at least one electronic circuit comprising a number of electronic components for performing the functionality of at least one of instructions 421-425, and/or other instructions.

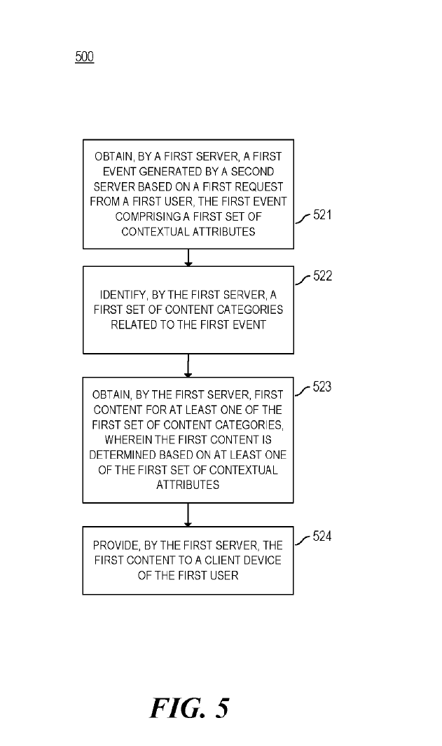

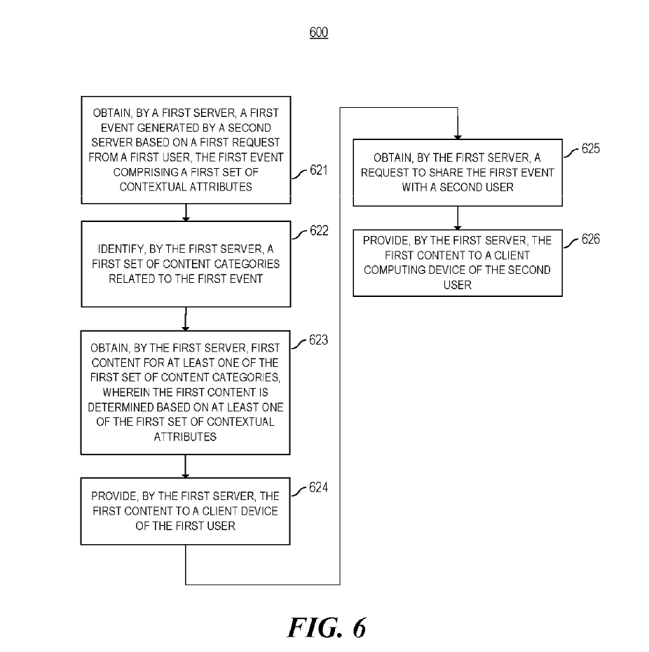

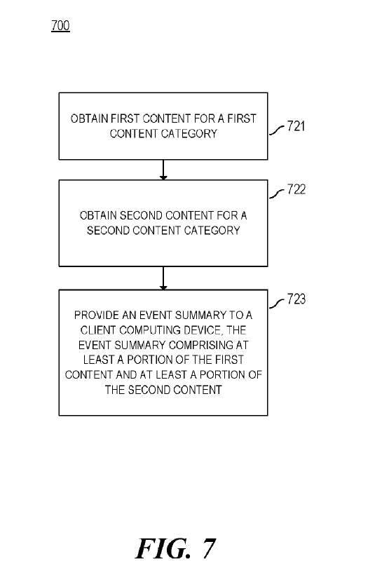

FIG. 5 is a flow diagram depicting an example method 500 for obtaining content determined based on an event that is generated by an external transactional system. The various processing blocks and/or data flows depicted in FIG. 5 (and in the other drawing figures such as FIGS. 6 and 7) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in greater detail below) is meant be an example and, as such, should not be viewed as limiting. Method 500 may be implemented in the form of executable instructions stored on a machine-readable storage medium, such as storage medium 310, and/or in the form of electronic circuitry.

Method 500 may start in block 521 where a first server computing device may obtain a first event generated by a second server computing device (e.g., external transactional system 160 in FIG. 1). The second server computing device may publish or otherwise provide the generated event to the first server computing device. The first event may comprise a first set of contextual attributes. For example, a user may submit a helpdesk ticket through a second server computing device responsible for managing helpdesk tickets, which may include at least one contextual attribute such as the user's identification, the user's contact information, the issue that needs to be resolved, an importance level, a ticket creation time, etc. The second server computing device may publish or otherwise provide the helpdesk ticket along with the contextual attributes associated with the ticket to the first server computing device.

In block 522, method 500 may identify a first set of content categories related to the first event. The first event may be associated with a predefined set of content categories. For example, the “business travel” event may be associated with various content categories including flight, weather, map, hotel, currency, car rental, etc. The predefined associations between a particular event and a corresponding set of content categories may be stored in a data storage (e.g., a data storage 129 in FIG. 1).

In block 523, method 500 may obtain first content for at least one of the first set of content categories. The first content may be determined based on at least one of the first set of contextual attributes. In other words, the first set of contextual attributes may be used to generate content for the first set of content categories associated with the event. Returning to the above example, for the “weather” category associated with the “business travel” event, method 500 send the information about the arrival city to an external content source (e.g., external content source 170 of FIG. 1) such as a weather forecast service provider to retrieve and/or obtain the weather information related to the arrival city. The weather information related to the arrival city may be recommended to the user.

In block 524, method 500 may provide the first content to a client computing device of the first user. For example, the first user may, via a display coupled to the client computing device, receive and view the weather information related to the city that he or she is visiting for his or her upcoming business trip.

Referring back to FIG. 1, event obtaining engine 121 may be responsible for implementing block 521. Content recommending engine 122 may be responsible for implementing block 522 and 523. Communication engine 124 may be responsible for block 524.

FIG. 6 is a flow diagram depicting an example method 600 for sharing an event with another user. Method 600 as illustrated (and described in greater detail below) is meant be an example and, as such, should not be viewed as limiting. Method 600 may be implemented in the form of executable instructions stored on a machine-readable storage medium, such as storage medium 210, and/or in the form of electronic circuitry.

Method 600 may start in block 621 where a first server computing device may obtain a first event generated by a second server computing device (e.g., external transactional system 160 in FIG. 1). The second server computing device may publish or otherwise provide the generated event to the first server computing device. The first event may comprise a first set of contextual attributes. For example, a user may submit a helpdesk ticket through a second server computing device responsible for managing helpdesk tickets, which may include at least one contextual attribute such as the user's identification, the user's contact information, the issue that needs to be resolved, an importance level, a ticket creation time, etc. The second server computing device may publish or otherwise provide the helpdesk ticket along with the contextual attributes associated with the ticket to the first server computing device.

In block 622, method 600 may identify a first set of content categories related to the first event. The first event may be associated with a predefined set of content categories. For example, the “business travel” event may be associated with various content categories including flight, weather, map, hotel, currency, car rental, etc. The predefined associations between a particular event and a corresponding set of content categories may be stored in a data storage (e.g., a data storage 129 in FIG. 1).

In block 623, method 600 may obtain first content for at least one of the first set of content categories. The first content may be determined based on at least one of the first set of contextual attributes. In other words, the first set of contextual attributes may be used to generate content for the first set of content categories associated with the event. Returning to the above example, for the “weather” category associated with the “business travel” event, method 600 send the information about the arrival city to an external content source (e.g., external content source 170 of FIG. 1) such as a weather forecast service provider to retrieve and/or obtain the weather information related to the arrival city. The weather information related to the arrival city may be recommended to the user.

In block 624, method 600 may provide the first content to a client computing device of the first user. For example, the first user may, via a display coupled to the client computing device, receive and view the weather information related to the city that he or she is visiting for his or her upcoming business trip.

In block 625, method 600 may obtain a request to share the first event with a second user. In response to the request to share, the first event and associated content may be communicated or otherwise provided to the second user (block 626).

Referring back to FIG. 1, event obtaining engine 121 may be responsible for implementing block 621. Content recommending engine 122 may be responsible for implementing block 622 and 623. Communication engine 124 may be responsible for block 624. Event managing engine 123 may be responsible for implementing blocks 625 and 626.

FIG. 7 is a flow diagram depicting an example method 700 for providing an event summary. Method 700 as illustrated (and described in greater detail below) is meant be an example and, as such, should not be viewed as limiting. Method 700 may be implemented in the form of executable instructions stored on a machine-readable storage medium, such as storage medium 210, and/or in the form of electronic circuitry.

Method 700 may start in block 721 where method 700 obtains first content for a first content category and obtain, in block 722, second content for a second content category. An event summary may be generated where the event summary comprises at least a portion of the first content and at least a portion of the second content. For example, the event summary may include a snippet portion of the individual content associated with a particular event such that a user may receive a high-level overview of the entire event. The event summary of the “business travel” event, for example, may include a portion of weather content, a portion of hotel content, a portion of flight information content, etc. In block 723, method 700 may provide the event summary to a client computing device for the user to view.

Referring back to FIG. 1, content recommending engine 122 may be responsible for implementing block 721 and 722. Communication engine 124 may be responsible for block 723.

FIG. 8 is a diagram depicting an example user interface 800 for displaying an event stream and managing events in the event stream. User interface 800 (and other user interfaces described herein) may be used to cause various actions to be performed by event-based content system 110.

User interface 800 may include an event stream that displays any new events communicated to a user in the same display view. The event stream may function as an inbox for the new events. In the example illustrated in FIG. 8, new events including Event 1 (e.g., item 821), Event 2 (e.g., item 822), and Event 3 (e.g., item 823) appear in the same display view. In one example, Events 1-3 may be arranged in a chronological order (based on the creation time of each event, the creation time of a content item in the event, a due date/time or an expiration date/time associated with the event or a content item in the event, the time of communication or delivery of the event or a content item in the event, etc.). In another example, Event 1-3 in the event stream may be arranged based on an importance level, a priority level, a level of urgency, etc.

In some implementations, the user may communicate which action the user wants to perform on a particular event appearing in the event stream using a swipe gesture on a touch-screen display. A “swipe” is a touch comprising an initial contact with the touch-screen display and a subsequent motion across the screen. For example, based on an indication of a swipe gesture with respect to a particular event, the user may easily snooze, archive, or delete the particular event. In the example depicted in FIG. 8, the user may touch on Event 3 (e.g., item 823) and perform a right swipe to archive Event 3. One more right swipe may cause Event 3 to be deleted in this example. To snooze Event 3, the use may touch on Event 3 and swipe in the left direction. One more left swipe may cause a list of all of the events (e.g., new events, archived events, snoozed events, etc.) to be displayed to the user via user interface 800.

The foregoing disclosure describes a number of example implementations for communication of event-based content. The disclosed examples may include systems, devices, computer-readable storage media, and methods for communication of event-based content. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 5-7 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for execution by a computing device for communicating event-based content, the method comprising:
obtaining, by a first server computing device, a first event that is generated by a second server computing device based on a first request from a first user, wherein the first event comprises a first set of contextual attributes that describe the first event;
identifying, by the first server computing device, a first set of content categories that are related to the first event;
obtaining, by the first server computing device, first content for at least one of the first set of content categories, wherein the first content is determined based on at least one of the first set of contextual attributes; and
providing, by the first server computing device, the first content to a client computing device of the first user.

2. The method of claim 1, further comprising:
receiving, by the first server computing device, a second request from the first user;
generating, by the first server computing device, a second event based on the second request, wherein the second event comprises a second set of contextual attributes that describe the second event;
identifying, by the first server computing device, a second set of content categories that are related to the second event;
obtaining, by the first server computing device, second content for at least one of the second set of content categories, wherein the second content is determined based on at least one of the second set of contextual attributes; and
providing, by the first server computing device, the second content to the client computing device of the first user.

3. The method of claim 1, wherein the first set of contextual attributes comprises at least one of temporal context, locational context, and user context.

4. The method of claim 1, further comprising:
obtaining, by the first server computing device, the first content for a first content category of the first set of content categories;
obtaining, by the first server computing device, second content for a second content category of the first set of content categories; and
providing, by the first server computing device, an event summary to the client computing device of the first user, the event summary comprising at least a portion of the first content and at least a portion of the second content.

5. The method of claim 1, further comprising:
obtaining, by the first server computing device, a request to share the first event with a second user; and
in response to the request to share, providing, by the first server computing device, the first content to a client computing device of the second user.

6. A non-transitory machine-readable storage medium comprising instructions executable by a processor of a computing device for communicating event-based content, the machine-readable storage medium comprising:
instructions to obtain a first event associated with a set of contextual attributes that describe the first event;
instructions to identify a first content category that is related to the first event;
instructions to determine whether the first event is active based on an event status associated with the first event; and
in response to determining that the first event is active, instructions to cause a display of a first content item that belongs to the first content category, wherein the first content item is generated based on at least one of the set of contextual attributes.

7. The non-transitory machine-readable storage medium of claim 6, further comprising:
instructions to identify a second content category that is related to the first event; and
in response to determining that the first event is active, instructions to cause the display of a second content item that belongs to the second content category, wherein the second content item is generated based on at least one of the set of contextual attributes.

8. The non-transitory machine-readable storage medium of claim 6, wherein the event status comprises an active status and an inactive status, wherein the active status comprises information about the first event being in progress and the inactive status comprises information about the first event being closed, being complete, being expired, or not yet being started.

9. The non-transitory machine-readable storage medium of claim 6, wherein the first event is triggered by a first request from a first user, further comprising:
instructions to obtain a second event that is triggered by a second request from a second user;
instructions to store the second user's interaction with at least one content item generated for the second event;
instructions to identify a third content category related to the first event; and
instructions to cause the display of a third content item that belongs to the third content category, wherein the third content item is generated based on in part the second user's interaction.

10. The non-transitory machine-readable storage medium of claim 6, further comprising:
instructions to obtain, by a first server computing device, the first event, wherein the first event is generated by a second server computing device.

11. A system for communicating event-based content comprising:
a processor that:
obtains a first event comprising a first set of contextual attributes that describe the first event, wherein the first event is generated based on a first request from a first user;
identifies a first set of content categories associated with the first event;
obtains a first content item to be recommended for at least one of the first set of content categories, wherein the first content item is generated based on at least one of the first set of contextual attributes;
communicates, via a display, the first event comprising at least a portion of the first content item to the first user;
stores the first user's interaction with the at least a portion of the first content item;
obtains a second event comprising a second set of contextual attributes that describe the second event, wherein the second event is generated based on a second request from a second user;
identifies a second set of content categories associated with the second event; and
obtains a second content item to be recommended for at least one of the second set of content categories, wherein the second content item is generated based on in part the first user's interaction.

12. The system of claim 11, wherein the display is a touch-screen display, the processor that:
receives, via the touch-screen display, an indication of a swipe gesture with respect to the first event; and
determines whether to snooze, archive, or delete the first event based on the swipe gesture.

13. The system of claim 11, the processor that:
obtains a third event comprising a third set of contextual attributes that describe the third event, wherein the third event is generated based on a third request from the first user;
identifies a third set of content categories associated with the third event;
obtains a third content item to be recommended for at least one of the third set of content categories, wherein the third content item is generated based on at least one of the third set of contextual attributes; and
communicates, via the display, the third event comprising at least a portion of the third content item to the first user, wherein the first event and the third event are displayed in the same display view.

14. The system of claim 13, wherein events displayed in the display view are arranged based on at least one of temporal information related to the events and priority information related to the events.

15. The system of claim 11, wherein obtaining the first content item comprises:
sending the at least one of the first set of contextual attributes to an external content source that corresponds to the at least one of the first set of content categories; and
obtaining the first content item from the external content source, wherein the first content item is generated by the external content source based on the at least one of the first set of contextual attributes.
